(19) United States
(12) Patent Application Publication
(10) Pub. No.: US 2013/0206017 A1
(43) Pub. Date: Aug. 15, 2013

(54) CITRUS JUICE EXTRACTOR

(71) Applicant: Tostado Tellez Salvador, San Martin Texmelucan de Labastida, Pue. (MX)

(72) Inventor: Tostado Tellez Salvador, San Martin Texmelucan de Labastida, Pue. (MX)

(73) Assignee: KRTN, S.A. de C.V., Puebla, Pue (MX)

(21) Appl. No.: 13/880,340

(22) PCT Filed: Oct. 18, 2011
(86) PCT No.: PCT/MX2011/000129

§ 371 Date: Apr. 18, 2013

(30) Foreign Application Priority Data
Oct. 18, 2010 (MX) MX/A/2010/011417

(51) Int. Cl. A23N 1/00

(52) U.S. Cl. CPC A23N 1/003
USPC 99/501

(57) ABSTRACT

The invention relates to a juice extractor including an intermediate casing having side surfaces that define an upper inlet window and a lower outlet window, said casing including a transverse wall having a vertical section, an inclined section, and a lower vertical section arranged to define a step and, therebelow, a rear housing in which an electric motor is placed, coupled to a helical gear via an endless screw, the helical gear including a safety system allowing same to slip in the event of an overpressure; gears on the rear surface of the transverse wall of the intermediate casing disposed in an ascending cascade configuration; a rear lid that conceals or protects gearing and electric motor; separate access ramps for grapefruits, oranges, lemons, each ramp including a pin which actuates a safety switch; and gearing and squeezing devices (volute and bobbin) assembled on the faces of the intermediate casing.

### FIELD OF THE INVENTION

This invention relates to an automatic machine to squeeze citrus juice; specifically to a squeezer provided with a safety switch, and specific access ramps for grapefruits, oranges and lemons, i.e., which selects the appropriate opening and extractor pressure according to the fruit size.

### BACKGROUND OF THE INVENTION

In the current state of the art there are plenty of juice extractors, from the manual extractor to the automatic machines which cut the fruit and discard the seed; but most of them use an extraction mechanism based on a concave cavity and a convex male set screw which presses the fruit against the concave cavity to squeeze the juice.

The French patent FR 2,936,935, published on Apr. 16, 2010, the inventor of which is Fevre Loic Xavier et al, describes a centrifugal juice extractor which consists in an inner scraper disk covered by a semi-round case with an upper conduit used to insert the food and a side conduit used for juice collection; the device requires constant cleaning in order to extract the resulting bagasse.

The United States patent US 2010/0058940, published on Mar. 11, 2010, whose inventor is Adrián Rivera; describes an automatic juice extractor which presses and turns the fruit around a vertical cylindrical body. Such body is equipped with a lid and a female-male mechanism connected to a central vertical shaft which includes a rope allowing for upward movement and pressure to be exerted on the conical surface to extract juice.

The International patent application WO 2009088275, published on Jul. 18, 2009, whose inventor is Luis Torres Huato, describes an automatic machine to squeeze citrus juice; the machine has as upper reservoir or hopper which only allows for the insertion of one orange, a knife to cut orange or citrus slices which are fed between two horizontal rollers rotating in opposite directions to extract the juice from such slices, so that said juice can be collected in a lower container free of bagasse.

The European patent application EP 2120612, published on Nov. 25, 2009, the inventor of which is Erik Lebrun, describes a juice extractor with a side feed ramp for oranges which arrive at a “quarter-cutting” first station and feed a pressure dome supplemented by a vertical pressure rotating cone where juice extraction occurs.

The German patent application DE 102007021456, published on Apr. 30, 2009, whose inventor is Medvetskiy Oleksandr, describes an orange juice extractor which extracts juice between a plate and the pressure exerted thereon by a piston, the cylinder containing the plate defines a free space where such extracted-by-pressure juice can be collected.

The Spanish patent ES 2,316,259, published on Apr. 1, 2009, the inventor of which is Fernando Deza San Baudilio, describes a juice squeezer provided with a female roller with peripheral alveolus where fruits such as oranges may be stored, and a male roller provided with radial squeezing cores (this roller arrangement allows for a substantial reduction in the volume of the extractors available in the state of the art), the female roller is provided with a cutting knife and a deflector related thereto through which the upper half of the orange may be placed in the next alveolus and well-positioned for juice extraction by the radial squeezing cores.

The Mexican patent application MX 2009002904, published on May 28, 2009, and which corresponds to the Japanese application JP 2010503419, whose inventor is Salvatore Torrisi et al, describes an automatic machine for juice extraction, equipped with functional items which allow for easier cleaning; provided with a lower motor assembly, quick coupling means, with an upper cylindrical-tank-like juice extraction chamber with rotating features aligned with an eccentric mechanism.

The international application WO 2009035313, published on Mar. 19, 2009, whose inventor is Salvador Tostado Téllez, describes a juice extractor provided with rotating features intended for extraction and pressure, such as a bobbin and a volute with plastic surfaces bearing a lineal arrangement of pins which squeeze the fruit in the middle to extract the juice. Such extraction means are held by two vertical side panels, and the mechanism is driven by an electrical motor located near the center of the panel. The extractor is unstable since its center of gravity is located above the middle; it has grooves where juice may leak causing grime, and it is difficult for users to assemble the extractor for cleaning purposes. Therefore, this extractor should be improved to offer better stability, easier assembly for cleaning and better extraction surfaces (to prevent early wearing out).

The French patent FR 2898796, published on Sep. 28, 2007, whose inventor is Guy Lyonnaz, describes a hand juice extractor including a lower concave surface, to place a half of the fruit thereon, on an end and with rotation, a convex lever is set, which connected with the concave lower surface extracts the fruit juice.

The Spanish patent ES 2272166, published on Apr. 16, 2007, whose inventor is Ignacio Horche Trueda et al, describes an automatic juice extraction machine, the main extraction item of which consists in a rotary cone-shaped head which is also capable of oscillating up and down, and is equipped with razors that grind the fruit to press it and extract the juice. This extractor does not offer an automatic waste disposal mechanism.

The Spanish patent ES 2,170,602, published on Aug. 1, 2002, whose inventor is Francisco Cremades del Toro, describes a juice extraction machine, equipped with a pressure mechanism made up of a female cup and a male cone driven by a spindle that moves a vertical shaft, also provided with uniformly-spaced angular knives that cut the fruit in segments and secure an efficient juice extraction. This machine, however, fails to include an automatic waste/seed disposal mechanism.

The United Kingdom patent GB 2216784, published on Oct. 25, 1989, whose inventor is Gómez Carmen Llopis, describes an automatic orange juice extraction machine, equipped with two parallel female rollers and two male rollers aligned with each other, the female rollers cut the oranges in half, each half is then lodged in each roller; during rotation they meet in the male head of the lower rollers which press the fruit to extract the juice; the casing has two side ramps to drop the peel and a lower opening through which the juice is expelled to be collected by a separate container (which is not part of the machine).

### BRIEF SUMMARY OF THE INVENTION

This invention is intended to provide a juice squeezer equipped with an intermediate casing where the mobile-juice-extraction items are connected, together with their own driving mechanisms.

This invention is also intended to provide a juice squeezer with a mass center located at a line close to the support surface, resulting in a juice extractor with improved stability.

This invention is also intended to provide a juice squeezer with safety switches on its access and exit ramps, on the front lid.

Besides, this invention is intended to provide juice extraction elements with metallic pins and surfaces.

Furthermore, this invention is intended to provide a juice squeezing bobbin, with a die-cut steel ring located around the square center.

This invention is also aimed at providing a driving mechanism, with a new gear arrangement and a drive protection system intended to protect the equipment when fruit halves get stuck.

This invention is also intended to provide a juice squeezer with access and discharge ramps which impede the entrance of the user's hand or any other long object capable of reaching the moving parts of the machine, such as the volute and the bobbin which rotate to extract the juice.

This invention is aimed at providing a juice squeezer with a rear lid intended to isolate the gears and the motor, where the gear shafts are secured and where there are windows with holes designed for motor ventilation purposes.

Besides, this invention is intended to provide a juice squeezer with a bobbin redesigned with two complementary metallic plates with pins, which plate is fused together with the bobbin body.

This invention is intended to provide a juice squeezer with a volute made up of two halves, the surface of which is covered by rows of pins.

This invention is also intended to provide a juice squeezer with a juice collecting jar situated at the front and on the base of the said juice extractor.

### BRIEF DESCRIPTION OF THE DRAWINGS

FIG. 1 is a side view in perspective which shows the outer part of the juice extractor which is the subject-matter of this invention.

FIG. 2 is a front view in perspective which shows the assembly of the two extraction surfaces, bobbin and volute in the intermediate casing.

FIG. 3 is a front view in perspective of the intermediate casing where the elements making up the driving mechanisms are lodged.

FIG. 4 is a view in perspective of the inner face of the rear lid.

FIG. 5 is a side view in perspective which mainly shows the location of the motor and related gear, as well as the safety switches.

FIG. 6A is a rear view of the coupled driving system, and also shows the safety switches, outlet, forward and backward motion.

FIG. 6B shows an exploded view in perspective of the elements comprising the helical gear, provided with the spring clutch designed for gearing protection in case of jams.

FIG. 7 is a lateral section in perspective of one bobbin and volute section in its normal use position, and also shows the access ramp which leads the citrus half into the intersection of the said two parts in order to squeeze it and then throw the peel out of the exit ramp.

FIG. 8 is a front lateral view in perspective which shows the location of the juice collecting jar, the position of the collecting tray, the access and exit ramps, and the squeezing bobbin and volute.

FIG. 9 is a view in perspective of the access ramp for oranges.

FIG. 10 is a view in perspective of the exit ramp.

FIG. 11 is a view in perspective of the access ramp for grapefruits.

FIG. 12 is a view in perspective of the access ramp for sour lemons.

FIG. 13 shows an exploded view of the bobbin, the two sections of the metal sleeve with pins and the rectangular edges of the center with a die-cut steel ring which is used as a reinforcement and safety device.

FIG. 14 shows an exploded view in perspective of the components of the adjustment knob which defines the opening suitable for each type of fruit.

FIG. 15 shows a view in perspective of the juice collection jar, which slides down into the edge of the front lid.

FIG. 16 is a view of the front lid of the extractor and shows the grooves that define the opening of the shafts on which the bobbin and the volute are mounted to determine the amount of pressure required by the fruit.

FIG. 17 is a front view of the inner part of the front lid, which shows the housings of the knob latch, as well as the reinforcement ribs provided for the body of the lid.

### DETAILED DESCRIPTION OF THE INVENTION

This invention has introduced significant changes in connection with the international application WO 2009035313, corresponding to the Mexican application MX 2007011257, in order to solve many of the issues raised therein, such as the lack of stability of the extractor (which had its center of gravity located over the central line as a result of its motor and gear arrangement), and the grime problems posed by said machine (as a result of juice leaking into the set of grooves laid out on its front and intermediate lid). Besides, this invention did not have any safety switches, which are now added on the intermediate casing and ramps of the equipment.

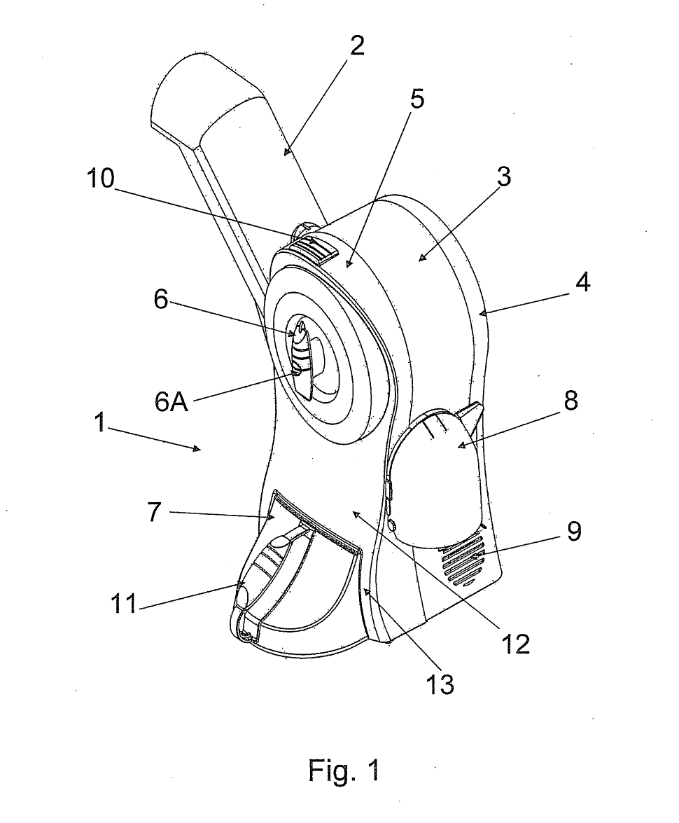

The juice extractor (1) of FIG. 1 has a different external appearance, with access ramps (2) with an initial curvature intended to prevent the access of fingers or long tools which could damage or block juice extraction rotary parts, the squeezing device comprises one bobbin and one volute, not shown; said parts are attached within the intermediate casing (3) on the front face of which the rotary volute and bobbin are located to press the citrus half and extract the juice; it has lateral arched windows where the access ramp (2) and the lid (8) of the exit ramp are attached; it has peripheral flanges that house the rear lid (4) and the front lid (5) which is further secured by a fastener (10) located within one upper-internal guiding slot of the front lid (5); said lid (5) has a central hole on a round casing where the adjusting knob is connected (6) which by means of an eccentric bolt defines the suitable opening or distance between the bobbin and the volute, such items squeeze the citrus juice by rotation, thus defining the pressure required to process grapefruits, oranges or lemons; on the front lid base (5) there is a window defined by two legs (13) between which the jar is inserted (7) to collect the juice, an intermediate curved flat body is also defined (12) to create an area to house the jar, which may be slid in and out to pour the juice accumulated therein, by means of a fix lever (11) that allows for an easy handling of the jar to collect and empty the juice.

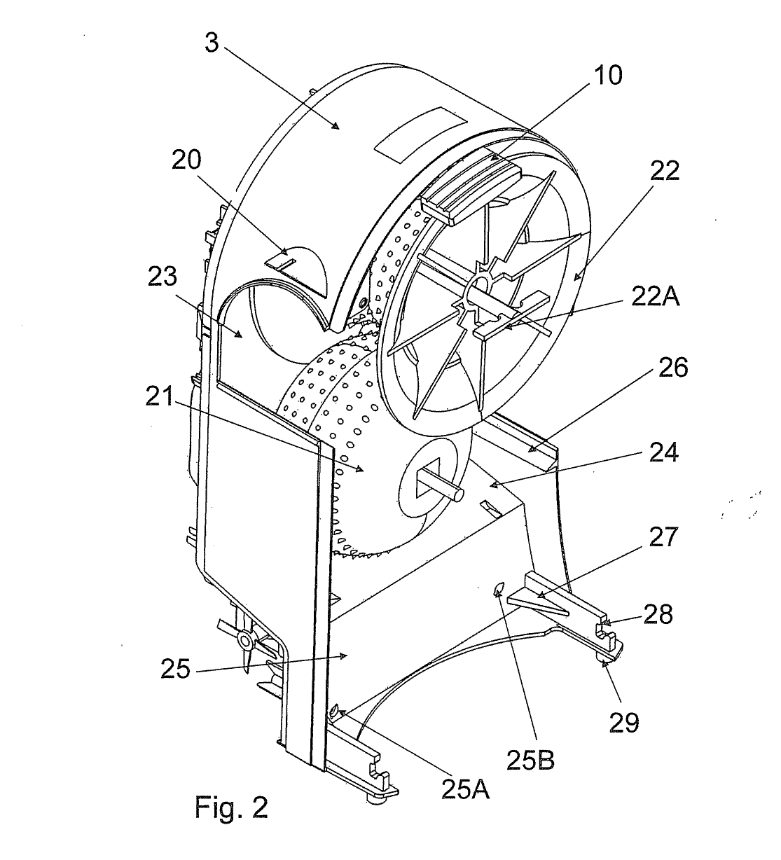

FIG. 2 shows a view of the intermediate casing (3) with its internal layout consisting in an upper vertical wall with two holes where the retaining shafts of the bobbin (22) and the volute (21) may be placed; once the retaining shafts have been placed, both devices, bobbin (22) and volute (21) must be coupled one into the other or one on the other, i.e., they must enter together and at the same time. Right after the vertical wall (23) there is a downward-inclined ramp (24) which defines a step at the front and a lower housing at the back, where the electric motor of this invention is placed; on the inner face of the lateral walls, there is an horizontal rib (26) which serves as a guide for the collecting tray as well as a drain to avoid undesired juice buildup; next to the ramp, (24) which is placed in the window flanges and is fastened by such flange (20), there follows a wall (25) with a forward inclination ending on the intermediate casing support base (3), such wall serves as a division to separate the motor and the juice collecting jar located on the front face of the wall, it includes two through holes (25 A and 25 B) which lodge the rear lid retaining screws from the inside or by the guides of the rear level posts. On the base, it has two parallel dowels with their respective guides (27) intended to hold the jar, a groove (28) which serves as a stop for the front lid, and a cylindrical step on the dowel's lower face, (29) which is used as a base and is covered by a neoprene sleeve to prevent the extractor from sliding as a result of the motor vibration caused by juice extraction. The intermediate casing (3) houses the gears in its rear face as well as the driving system actuated by a transversal electric motor located under the back of the sloped ramp (24) and the wall (25), respectively, the casing (3) is made up of only one part, without any assembled parts, therefore preventing any flow leaking towards the rear face and vice versa, and avoiding contamination from the rear external area to the front face. It is worth mentioning that both the female bobbin (22) and the male volute (21) must be placed together and mounted on their own shaft, otherwise, the bobbin edges would not allow the volute to move, so the male volute is placed out of the axes, on the female bobbin surface, aligning with its respective shafts in that position, which is its normal use position. The bobbin shaft has a groove on its end which is used to insert a metallic key (22 A), in one of the modalities, whereas in another a sleeve is placed to support an alternative positioning mechanism, in which the adjusting knob is placed to select the opening that should be used for grapefruits, oranges or lemons.

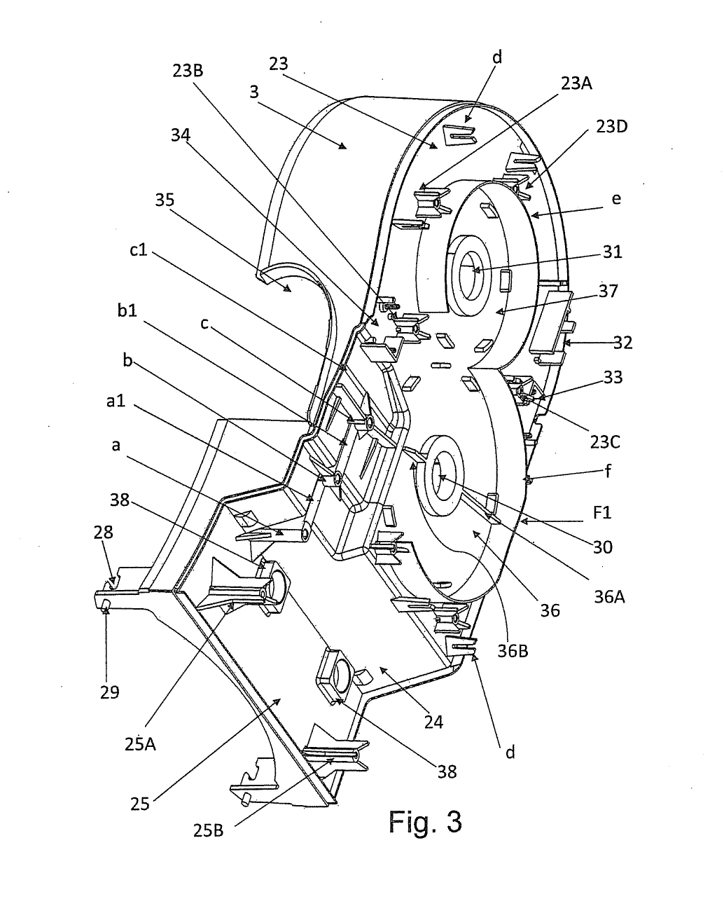

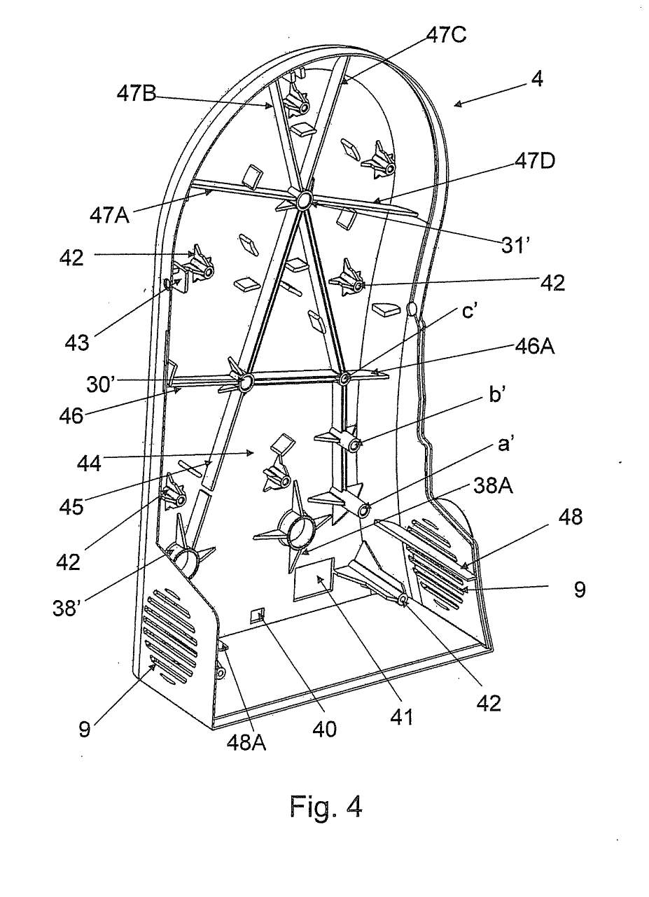

FIG. 3 shows a rear view of the intermediate casing (3) which is provided with a plurality of seats, shaft guides and housings (as described hereinbelow), in the base dowel there is a bolt (29) intended to avoid involuntary shifting over the appropriate location, there is also a groove (28) to insert the lower edge of the collecting jar and, in conjunction with the front lid, they make the complete window (35) of the exit ramp. On the vertical wall (23) there are several cable guides, (d) the space (37) of the bobbin gear with the hole (31) provided for its shaft, and the (e) perimeter vertical wall, it also shows the space (36) of the volute gear with the hole provided (30) for said volute shaft, and the perimeter vertical wall (f) which functions as a guard against the splash caused by the normal rotation of the gear assembly, the vertical wall has a reduced-height section (F1) specially designed to avoid any collision with the rear lid edge; besides, near the edges on the said vertical wall (23) there are three safety micro switches which prevent the motor from starting whenever the rear lid is not properly placed, as well as the exit ramp and even the access ramp; namely, a housing (32) for the micro switch controlling the front lid position, a housing (33) for the micro switch controlling the access ramp position, and a housing (34) controlling the correct positioning of the rear lid; it is worth noting that if any of such elements (i.e., front/rear lid, access/exit ramp) is not positioned at its correct operating location, the juice squeezer will not start or work; this safety measure can be implemented by means of the above-mentioned micro switches. The reverse side of the sloped wall (25) has two aligned bases (38) to receive two of the motor retaining devices, the other two retaining items are located in two bases of the rear lid inner face; once the motor is placed on the base (38), a helical gear is inserted into the guide (a), said gear is actuated through the motor shaft that has a spindle or worm shaft on its end, from the helical gear there follows a set of gears that are placed on (b y c), the gear (c) actuates the volute shaft gear, which in turn transmits its rotational movement to the bobbin gear—with fewer teeth—, thus causing the bobbin to rotate at a higher angular speed than the volute; however, the external diameter of each surface matches the gear diameters, and as a result, the bobbin is subject to more wear and tear, the bobbin surface gets comes into contact with the citrus shell, i.e., with its hardest surface, therefore, a sleeve with metal pin rows is required, in order to improve the performance and durability of this part. The items or parts located on the rear face of the intermediate casing are hermetically separated of the mobile parts located on the front face, namely, the bobbin, the volute, the juice collecting tray, and the jar. The hole (31) where the bobbin shaft is placed, said shaft has an eccentric section that defines the bobbin position in respect of the volute surface, i.e., it adjusts the separation between them in order to determine the pressure that should be exerted during the “squeezing rotation”, thus adjusting the bobbin position for grapefruits, oranges and lemons; in the unlikely event such position were adjusted for lemons but the user inserted a grapefruit, the bobbin and the volute would surely not have an adequate opening and, as a result, the grapefruit would get stuck and overpressure would be generated between the bobbin and the volute; however, should such an event occur, the extractor described in this invention would be protected by safety devices such as a pressure gage on the helical gear and a reverse switch that makes the engine rotate counterclockwise to expel the stuck citrus fruit, in case of overpressure, the pressure gage allows the helical gear to slip without transmitting any rotation to the gear system, thus protecting the juice extractor which is the subject matter of this invention. The level seats (a, b, c, 25 A and B, 23 A-D) have lateral reinforcement flanges which cover them up to their top edges, in addition to the ribs (a1-d, 36 A-B) which are added as reinforcement items intended to support the torque generated by the motor and bring more stability to the intermediate lid body to avoid its accidental bending. FIG. 4 shows the inner face of the rear lid (4) with several level separators (42) reinforced by side flanges extending up to the upper end which define the separation between the intermediate casing and the coupled motor/gear and the rear lid (4); it also has separators and guiding holes that house the shaft ends on which the gears rotate, for the sake of consistency, the following corresponding elements are marked with the same symbol differentiated by an apostrophe, the bearing guide for the helical gear shaft is (a′), the motor support bases are (38′), the guides and houses for the other gear shafts are indicated as (b′, c′), the house and guide for the volute shaft is indicated as (30′), the bobbin shaft is (31′) the important items on the rear lid are (4) also the tab (43) that actuates the micro switch located on the edge of the intermediate casing rear face, as well as the windows (9) to ventilate the motor and prevent its overheating, the windows are diametrically opposed in order to generate a ventilation current that transfers the heat caused by the motor running, the said electric motor is fed by a cable (introduced through the hole) (40) and has a three-position hand switch that makes the motor move forward, rearward and neutral, which switch is lodged within the window space (41). The forward position is used to squeeze the juice, the backward or reverse position is used to solve the jams caused by the improper use of the machine and the neutral position is used to avoid accidents while disassembling and cleaning the parts in order to prevent any grime/filth buildup derived from fruit and juice fibers and fructose. The rear lid (4) has been reinforced by a plurality of ribs (45, 46, 46 A, 47 A-D, 48, 48 A) in the same manner as the level seats (42) that define the separation and support of the rear lid, the ribs provide rigidity to the rear lid body (4) and prevent it from bending as a result of the torque generated by the engine and the combination of gears.

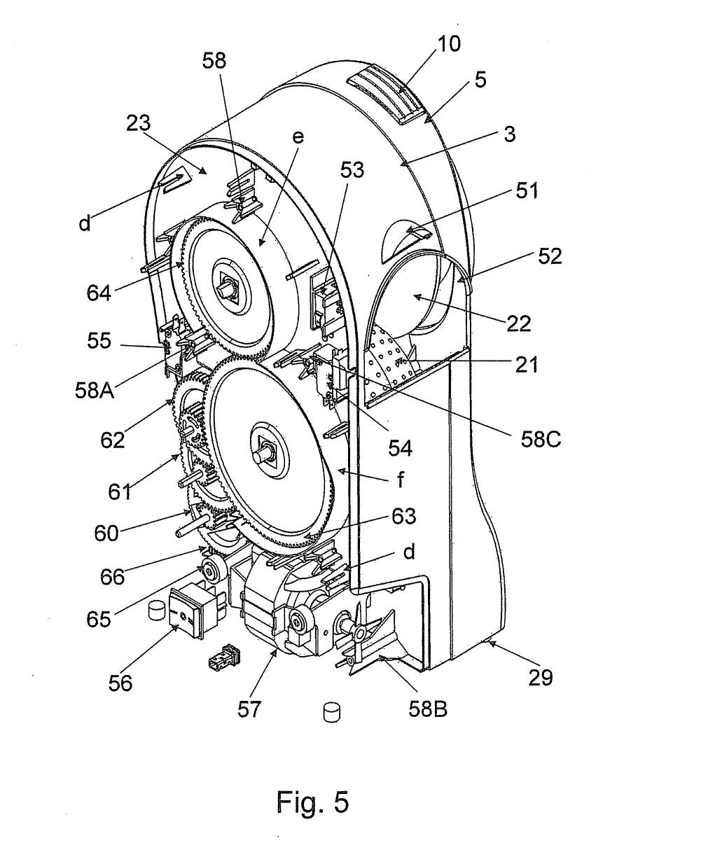

FIG. 5 shows the intermediate casing rear face (3) along with the various gears, the motor and micro switches positioned for use, the intermediate casing front face has the moving juice-extraction devices attached, to wit, the volute (21) and the bobbin (22), of which only a section is shown through the window (52) where one access ramp is placed (not shown) and secured on such window edges and on the casing stop (51) for the ramp upper edge, said casing is provided with a groove intended to house a clip or another device as a safety element intended to allow for the easy connection or removal of the access ramp from the window (52), made up of the intermediate casing (3) and the front lid or casing (5) and attached to the intermediate casing through the lid safety latch (10) and a groove on each of the lower dowels of the intermediate casing base (3). The descriptive importance of this figure lies in showing the location of each gear, the arrangement with the motor and the control devices such as the micro switches and the forward-reverse switch. The micro switch (53) controls and ensures that the rear lid is correctly connected over the perimeter of the intermediate casing, the micro switch (54) controls and ensures that the access ramp is correctly connected on the window edges (52), the micro switch (55) controls and ensures that the casing of the exit ramp is correctly connected on the exit window edges. The micro switches (53, 54, 55) are fed through a cable located in several clips or pliers (d), the vertical perimeter walls (e and f) prevent the bobbin (64) and volute gears (63) from catching any other foreign element and also function as an internal surface that blocks the splashes caused by such gears during rotation. Please note that the ends of the retaining shafts of the gear stand out beyond the plane defined by the gear in question, said protruding ends get connected in the guides located on the inner face of the rear lid, along with the support of (65) the electric motor (57), which is lodged at a lower housing of the intermediate casing rear face, said horizontal motor has a fan on one end which generates air current to cool such motor, on the other end of the shaft there is a spindle or worm gear (66) that couples with and causes the rotation of the helical gear (60) which has a spring-clutch safety system intended to protect the transmission against a potential overload; the gear (60) transmits the rotation movement to the gear (61) arranged in series in an ascending staggered line with respect to such gear (62) and such gear, in turn, to the volute gear (63) which also transmits the said movement to the gear (64) that rotates the bobbin, the driving system is therefore laid out in this staggered arrangement to rotate the set of citrus juice squeezing devices, made up by the motor, the gears, the bobbin and the volute. It is worth noting that the element with higher weight and mass is the motor (engine) and it is thus placed in a horizontal position and on the lower end of the intermediate casing (3) to secure a center of mass at a lower point and avoid the generation of moments of inertia derived from a high center of mass, with the above-mentioned arrangement the juice extractor contained in this invention describes a low center of mass, i.e., a center located in an area close to the support surface, which results in an improved stability during operation.

The switch (56) has three positions, one for the forward rotation that operates the extractor to squeeze the juice, a neutral position that stops the engine and a reverse position that causes the engine to run counterclockwise (in the event a fruit that is too large gets stuck between the surfaces of the volute and the bobbin, not to force the extraction machine), the engine is run backwards so that it can expel the half of the fruit that could not be processed through the opening or separation between the volute and the bobbin; a similar situation may occur when the bobbin and the volute opening is adjusted for lemons but a half of an orange or a grapefruit is inserted into the access ramp; however, to prevent such an adverse situation, this invention also offers feed ramps specially adapted to the particular sizes of lemons, oranges or grapefruits. The level and support seats (58-58C) have been reinforced with side vertical flanges intended to provide a better support frame between the intermediate casing (3) and the rear lid (4).

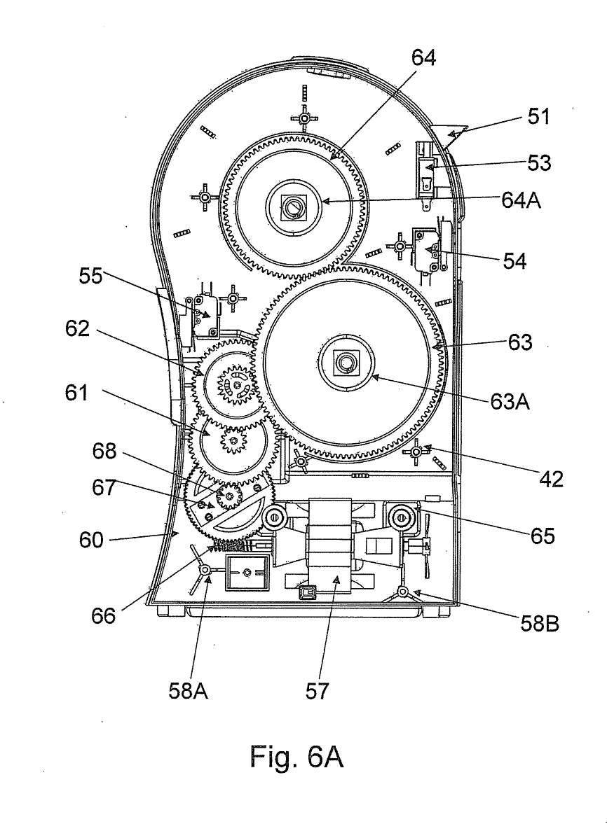

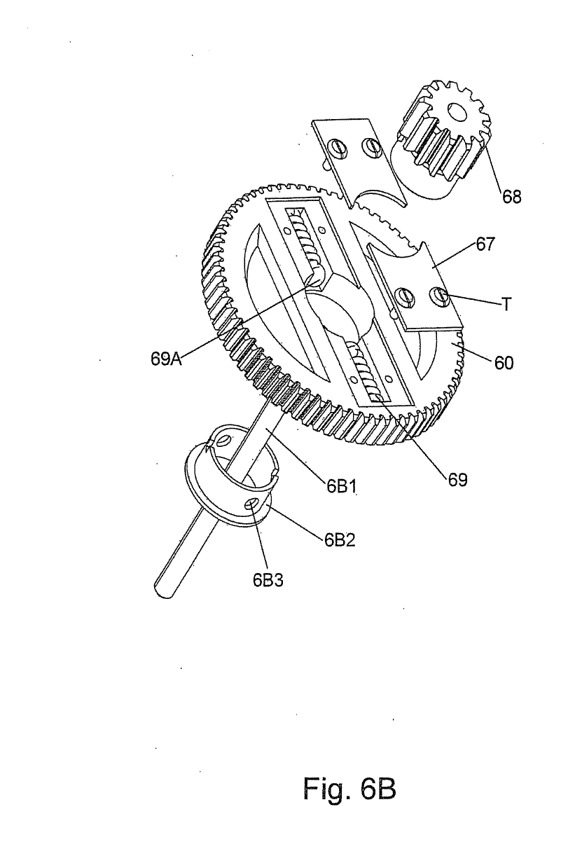

FIG. 6A shows a front view of the gear arrangement of FIG. 5; but the importance of this view lies in the safety system that protects the transmission, located at the helical gear, (60) coupled in an ascending cascade with the gears (61, 62, 63 and 64), where all the gear reinforcements are shown (63 A and 64A) corresponding to (63 and 64), all of them driven by the motor (57) through the spindle (66), the motor (57) is attached to the intermediate casing and the rear lid by means of the bolt bearings (65) which maintain the separation or the adequate level between the casings through the separating pins (42) that provide structural support to the set, while the micro switches (53, 54 and 55) control the safe operation of the equipment. The gear (60) has a safety system that protects the transmission, within the lids (67) and under the driving gear (68) there are two horizontal spring sections placed in radial position into a diametrical groove, on the inner end of each spring section there is a pellet or steel ball, said steel ball is stored in a hole of a central sleeve to the edge of which the gear bearing is attached (68) in the event of a jam, the pressure between the spindle (66) and the helical gear (60) increases until it passes the yield strength (elastic limit) of the spring sections and presses them towards the perimeter edge, thus allowing the sleeve to rotate without transmitting such movement to the gear (68), this way the motor does not burn out and no components or parts are damaged as a consequence of such overstress. Independently from the level seats (42) there are other reinforcing level seats in the lower section where the motor is stored, such seats (58 A and B) guarantee the appropriate fastening of the rear lid and the intermediate casing. This figure also shows the tab (51) provided to retain the feed ramp.

FIG. 6B shows an exploded view of the parts comprising the gear safety system (60). Namely, such gear (60) has a radial groove and a central hole; the groove is covered by the lids (67) by means of screws (T); at the central hole, a transmission gear is coupled on one side (68), and on the other side, the hole is coupled by a flange sleeve (6B2), while in the center there is the shaft or arrow (6B1); such sleeve has two side holes (6B3), which are diametrically opposed to each other, and on which the end pellets (69A) are partially introduced; at the notches of the ring side, the gear safety rib is coupled in order to assure the rotation of the system. The spring sections (69) are calibrated in such a way that they can support certain pressure without contracting. Under a jamming situation, when pressure increases, the spring elasticity is exceeded and the pellet gets out of its housing (6B3) for the gear (60) to rotate by sliding (uncoupled) on the ring (6B2) without forcing the motor and without a breaking hazard for the helical teeth of the spindle or gear (60). As a solution for a jamming situation, the three-position switch is activated in order to make the motor turn in the opposite direction (reverse); possibly, the pressure will be lower and the gear will be allowed to turn in the opposite direction; as a consequence, the disposal of the stuck fruit portion will also take place.

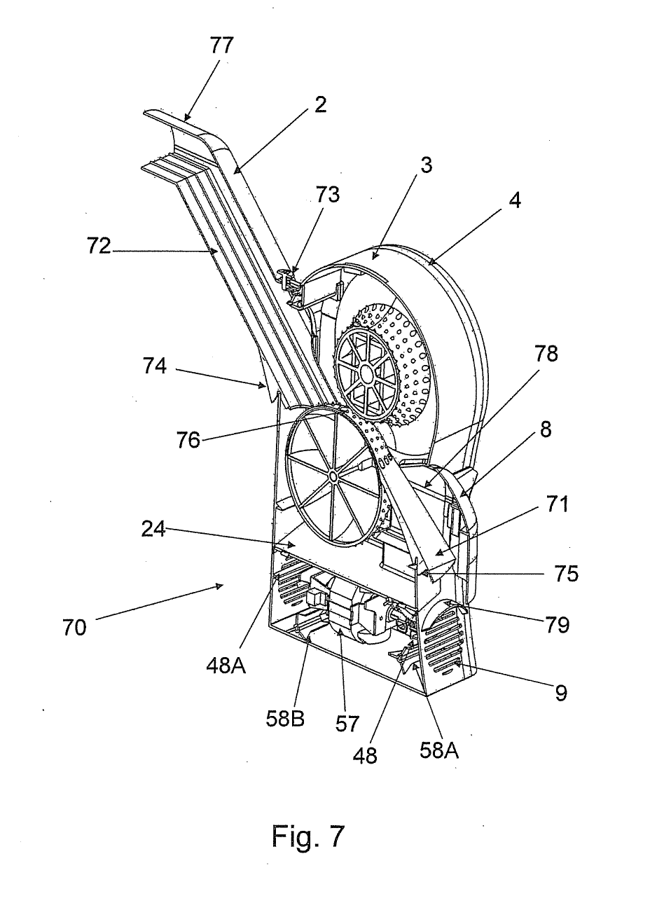

FIG. 7 shows a cross section (70) of the juice squeezer corresponding to this invention, where only half of the bobbin and the volute with its inner structure are shown; however, the important aspect of their arrangement is that the parallel lines of pins are staggered on their surface; there is a phase shift among the pin lines on the sliding surface; on a sag zone of the volute there will be a pin line corresponding to the bobbin and under a sag zone of the bobbin there will be a pin line (76) corresponding to the volute; both surfaces rotate at the same angular speed in order to trap half of the fruit and exert pressure on it; on the bobbin surface remains the hard and abrasive peel of the citrus processed for juice extraction; that is why, the bobbin surface is made of metal, formed by two over-molded plates (fused with the material of the bobbin body) that are integrated into the molded plastic that constitutes the plastic structural body of the bobbin; the smaller diameter of the bobbin has the same dimension as the gear diameter that makes the gear arrow turn. The volute is made up of two hemispheres consisting of two parts each joined by ultrasound in order to form only one round body that rotates in cooperation with the metal concave surface of the bobbin; the hemisphere or section of the citrus shall pass between both rotating surfaces so that juice can be extracted by means of the pressure exerted; the ramps make the discharge on the volute surface, while the waste ramp collects wastes from the volute surface. The upper ramp, which under this modality is the ramp (2), is adapted for grapefruit and has a sliding inner surface (72) connected by a step with a horizontal inlet area associated with a lid or safety cap (77) having a curve which prevents the accidental access of users' hand or fingers and that also prevents the access to moving parts; as a result of its length, it produces a moment of inertia when placing the citrus hemisphere or even the deliberate load of the hand; for this reason, a bracket is designed between the intermediate casing and the ramp cover; it is a casing or small flap with complementary accessories that has a groove, which receives a holding clip (73); with this clip-casing device, the casing can be assembled and disassembled in an easy and fast way, in addition to notch or support points (74); besides, resistance to accidental impact is guaranteed.

The sliding surface (72) consists of one inclined plane with parallel ribs discharged by the citrus hemisphere on the central surface of the volute, then it is pulled or sucked out towards the closest-approach area between the bobbin and the volute in order to squeeze juice by means of pressure; in the same inertial movement corresponding to the rotation, the waste is discarded through the exit ramp, which has a sliding surface (71) protected by an external lid (8) that prevents direct access to inner moving parts of the device; the exit ramp is attached to the edge of the outlet window in the intermediate casing by means of a lower coupling notch (75), which keeps the exit ramp in position between such edge and the rotating surface of the volute; on the contact end, it has some comb-type teeth with gaps to free the pin lines from the volute. Below the rotating parts there is an inclined transverse wall (24) that constitutes a lower housing, which contains the electric motor (57) in a transverse position; the motor generates a horizontal air current that serves as coolant; such current circulates through grates (9); the motor housing area is reinforced by means of side ribs (48 A and 48) and approach-level seats (58 A and B); the grates (9) are protected from the deliberate intake of juice drains by means of the flange (79) located just above the grate.

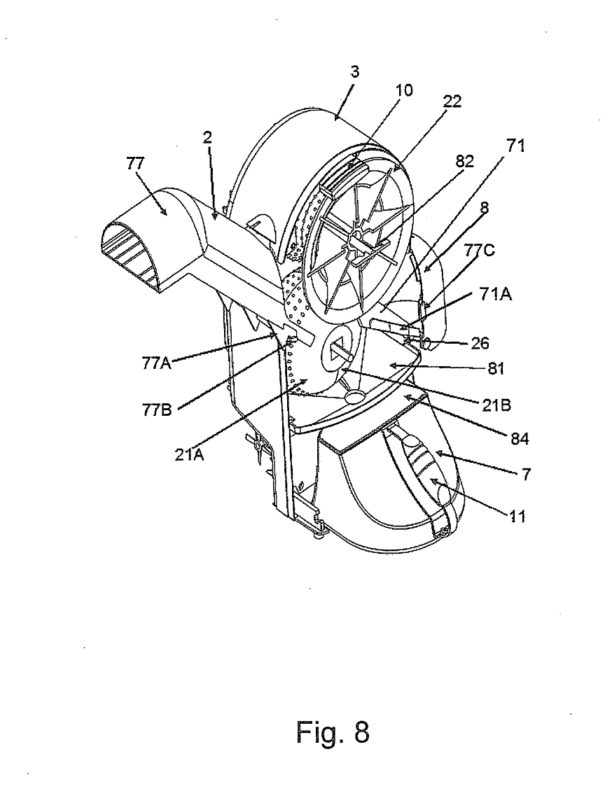

FIG. 8 is a front view in perspective of the juice squeezer described in this invention without front lid and with the ramp adapted to grapefruit (2) and the safety lid (77) in horizontal position which, together with the inclined section, form a curve that prevents direct access towards moving parts, which are the bobbin and the volute; such grapefruit ramp supports the lower edge of the inlet window and the casing (3) by means of two complementary casings that receive a clip, which locks the mechanism by rotation; the lower notches (77 A) support the ramp through the window edge (77 B); the grapefruit casing discharges on the volute with the sections (21 A and 21 B) that in cooperation with the bobbin (22) squeezes the juice, and the bagasse is discarded through the exit ramp (71) having two side-edge flanges (71 A), which also have a lid or casing (8) that prevents the access to moving parts in a direct way. A metallic key (82) is installed on a free end of the shaft supporting the bobbin, which in cooperation with the knob determines the opening of the free space between the volute and the bobbin; in a second modality, the bobbin shaft receives a ring with a crosshead and a releasing mechanism that allows the selection of the correct squeezing position in accordance to fruit size. The safety device (10) of the front lid is installed in such a way that when the front lid is placed (without any ramps), such safety device remains in the upper groove of that front lid and keep it in place; the safety device (10) and the base dowel notches are also supporting points of the front lid in cooperation with the access and discharge ramps. The collection chute (81) is located under the inclined ribs (26); the chute ribs and surfaces are inclined so as not to cause the accumulation of juice that is conducted towards a central hole, located in a place that matches with a hole present in the jar (7) lid (84), which is also placed in position through horizontal sliding on inner lower guides; once the jar is filled up or it is necessary to serve juice, it is taken by means of the handle (11) that allows to pour, remove or serve the juice. The jar has a design with esthetic and functional ends; for example, the nose is big enough to prevent the juice from being spilled when it is served; the jar lid has a sealing for isolating the juice from direct contact with the environment, and this jar containing juice can also be kept within the refrigerator.

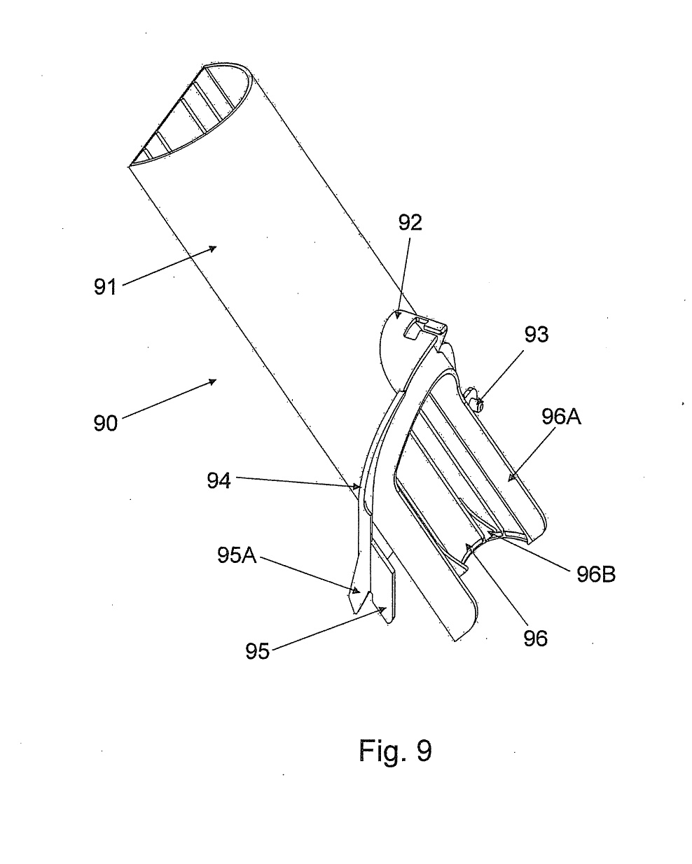

FIG. 9 shows a view in perspective of the ramp (90) appropriate for oranges; it is designed in only one piece and with the aim of leading the citric hemisphere to the center of the volute; by means of the change of ramps appropriate for grapefruits, oranges or lemons, it is possible for the user not to accidentally introduce a grapefruit or an orange in the position corresponding to lemons, causing the device to get stuck or producing a squeezing in a forced way; this is why, it is compulsory for the user to use the ramp and the position of the knob according to the correct size of citrus, and in this way, the device stated in this invention squeezes in an efficient manner; the three ramps are provided with a bolt that activates a safety micro-switch. The ramp for oranges (90) has a cover (91) that covers the sliding inner surface (96), which begins with a flat surface that has four ribs being longitudinal, parallel and loaded towards the sides, leaving a flat center; the discharge end has a mouth with a concave surface that assures the correct location of the fruit hemisphere being introduced into the center of the volute; on the edge, it has two flaps (96 B) that rise the fruit so that it reaches the correct squeezing position. The ramp for oranges (90) has a dowel with coupling notches (95 and 95 A) and a complementary casing (92) for fastening in another complementary casing, which is located on the intermediate casing; a supporting ring is associated with the body of the ramp; in one of the ends it has a bolt (93) that makes an automatic introduction in order to activate the safety micro-switch; if the bolt does not make any contact with the micro-switch, the device will not work, as a safety measure.

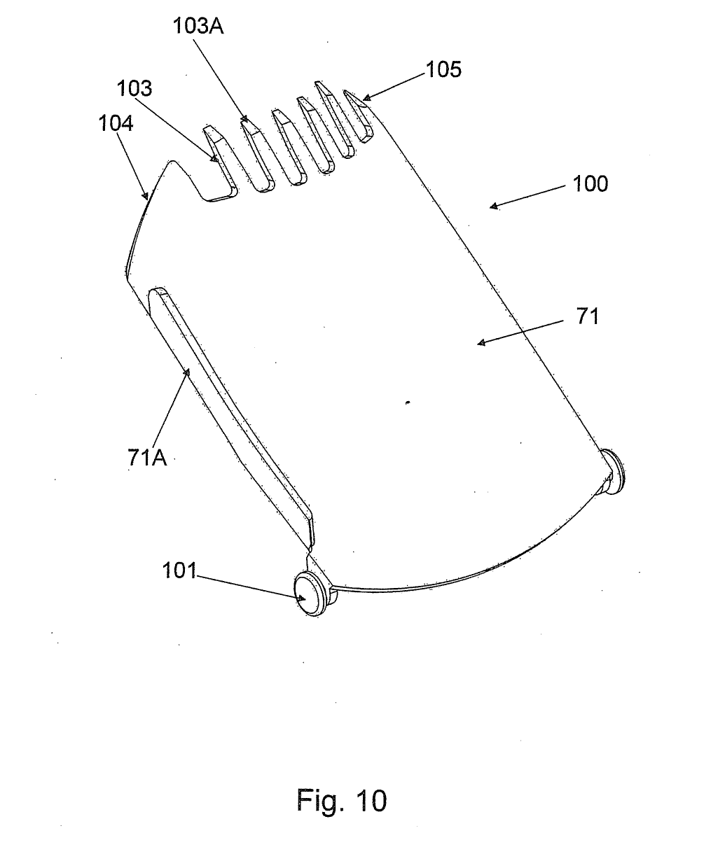

FIG. 10 shows a view in perspective of the exit ramp (100) that has a sliding surface (71) with a convex shape that is set in cooperation with the outlet lid through the supporting bolts (101); the sliding surface (71) has a side bar (71 A) that is used for retaining and preventing juice form being spilled and bagasse from being wasted. In the end in contact with the volute it has a series of aligned comb-type teeth (103) having gaps among each other for the pin lines corresponding to the volute surface to pass through them; the teeth (103) have an inclined sharp surface on their end (103 A) that serves as a scraper for the cleaning of the volute surface, and in that way avoiding the accumulation of grime on it; the teeth having a different end among each other (104 and 105) are appropriate for collecting bagasse.

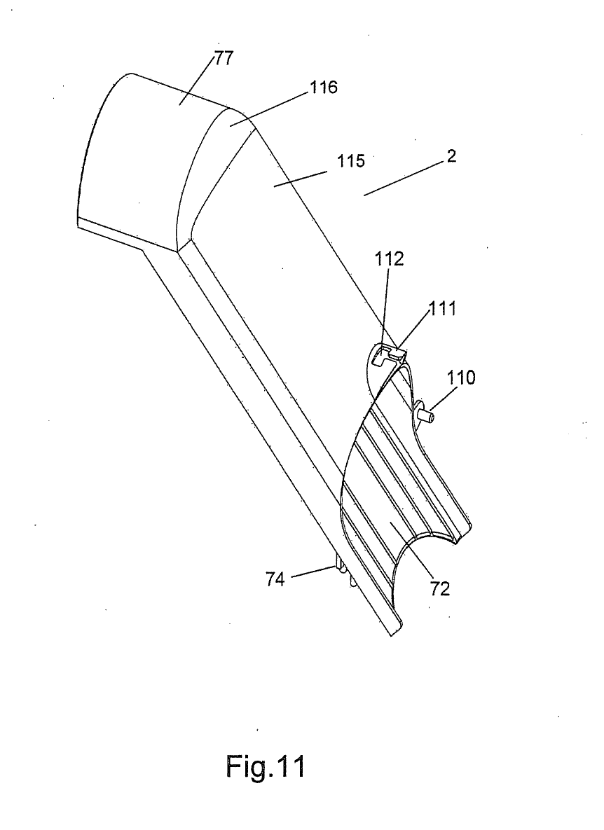

FIG. 11 shows a view in perspective of the, access ramp (2) for grapefruit, with the upper cover that when changed from horizontal to inclined (115) defines an elbow (116) that acts as a safety lid (77), whose curve prevents the access of the user's hand into moving parts, such as the roller or the volute; on the upper lid of the inclined section, a complementary casing (111) with notches (112) is added in order to receive a safety clip; it also has a safety bolt (110) that when coupled, the ramp activates the micro-switch validating the correct assembling of the ramp, by holding it by means of the notch (74) located at the lower end of the access window; it is also attached by means of the complementary casings (111) of the ramp and of the intermediate casing that are fasten through the safety clip. The sliding surface (72) of the fruit hemisphere has a mouth that is concave with respect to the exit in order to assure that the hemisphere is placed in the central part of the volute and on the pin area corresponding to it and to the bobbin. Again, if the bolt (110) does not activate the micro-switch, the device will not work, as a safety measure that guarantees a safe operation of the device.

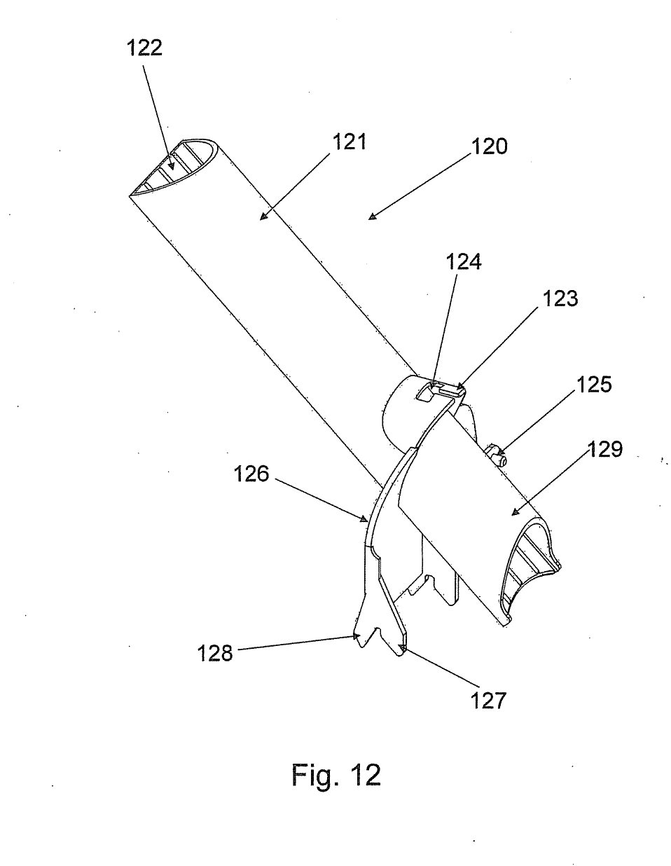

FIG. 12 shows a view in perspective of the ramp for lemons (120); note its straight union with the cover (121); this ramp does not have any curve parts because as a result of its small size, the user's hand does not fit to reach moving parts; however, the cover is necessary to assure that the insertion of the lemons is at a distance far enough from the moving parts. It is designed in only one piece and with the aim of leading the citric hemisphere to the center of the volute in order to assure an efficient squeezing. The ramp (120) has a sliding surface (122) formed by four parallel ribs, which are evenly distributed; it begins with a flat area and ends in a concave mouth in order to assure that the lemon halves are discharged at the center of the volute and that an efficient squeezing is obtained. The lemon ramp has a lid (126) and dowels (127) and (128) with coupling grooves, as supporting means, which together with the complementary casing (123) having a notch (124) introduce a safety clip that holds the lemon ramp. The ramp has an inner casing (129) that prevents the spatter of juice in reverse towards the inside of the device. All ramps have a bolt (125) that activates a micro-switch as a safety measure; that is, if the bolt (125) does not activate the micro-switch, the squeezer will not work.

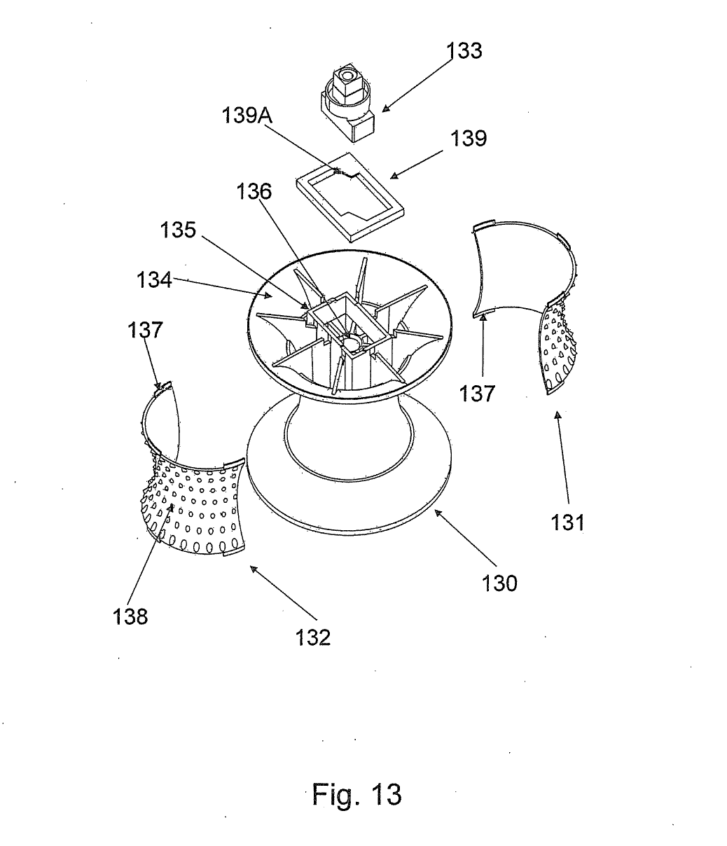

FIG. 13 shows a view in perspective and an exploded view of the pieces forming the bobbin (130) and the metal plates (131 and 132) with pins that have a diversity of flaps (137) on the sides of the edges with the aim of producing an over-molding when the piece is assembled (to fuse metal with plastic by placing the metal pieces inside the mold); that is, some plates (131 and 132) are placed together with the bobbin mold and the plastic material is injected; in that way, the plates (131 and 132) remain fused with the bobbin as if they were only one piece. The bobbin structure also has a die-cut steel ring around its square center (139) with notches at the inner opposed corners in order to act as a closing element for the tip (133); this is to reinforce the rectangular outline where the force of the bobbin tip is exerted. As it has been previously stated, the plates (131 and 132) are placed in the mold, then the plastic is injected and the plastic body (130) is formed with a metal sleeve, which is composed of metal plates (131 and 132), as well as metal pins (138) that are located on the outer surface; after the plastic is injected in the mold, the bobbin is formed with its inner reinforcing structure (134), the rectangular center (135) and the central hole (136), where the metal shaft that supports such bobbin passes through; the bobbin tip (133) is placed on the rectangular center (139) in order to align the arrow or the shaft. With these changes, a new bobbin is obtained with an improved performance, in the sense that it presents a greater resistance to wear and a greater gripping power and durability.

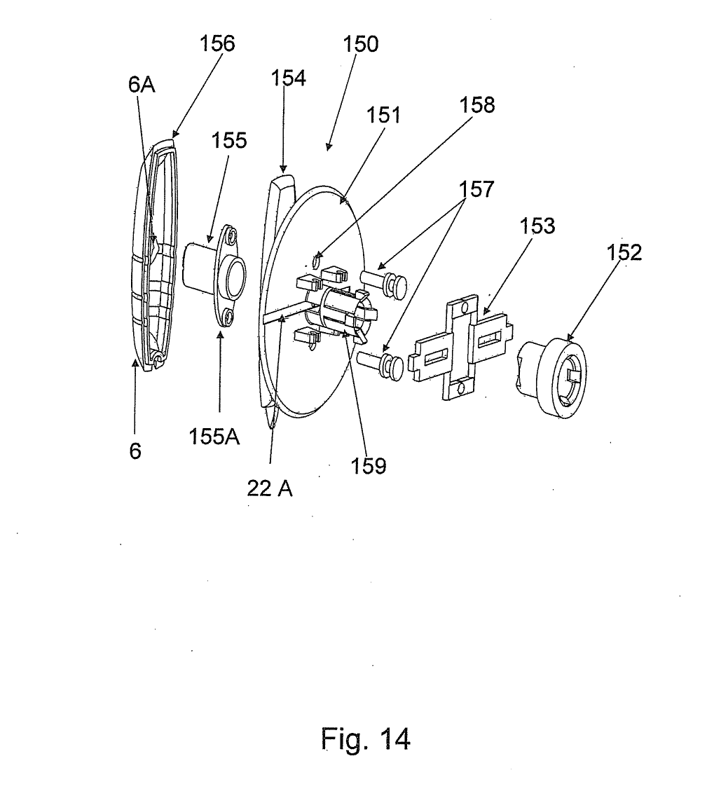

FIG. 14 is an exploded back view in perspective of the knob set (150) that allows the alignment of the right position to indicate the opening between the shafts or between the bobbin and the volute; in that way, the pressure exerted on the fruit is defined by means of the squeezing surfaces corresponding to the bobbin and the volute with the pertinent rotating movement. It consists of a knob lid (156) with a central hole (6 A) and an end edge (6); at the central hole (6 A), the cylindrical body (155) is introduced; this body is provided with a supporting base (155 A) that retains the bolts (157) after crossing and supporting the counter-knob (154) and its base (151); the bolts are crossed through the holes (158) of the base (151) rear face; in the center of such base there is a cylindrical body divided (159) with four notches having an inclined blade and regularly distributed in the outer edge; the cylindrical body has a base section communicated with the base (151); the base section has two vertical and diametrically opposed grooves that allow the placement of the key (22 A). On the outer side if the cylindrical body (159), the crosshead (153) is placed and within it, the bushing (152) is located with inner notches that are coupled in the grooves of the cylindrical body (159). The described mechanism forms a knob in which it is necessary to press the center to allow its rotation, or in which it is necessary to press the cylindrical body (155) in order to free the assembly and allow the rotation to select the squeezing position of grapefruit, lemons or oranges.

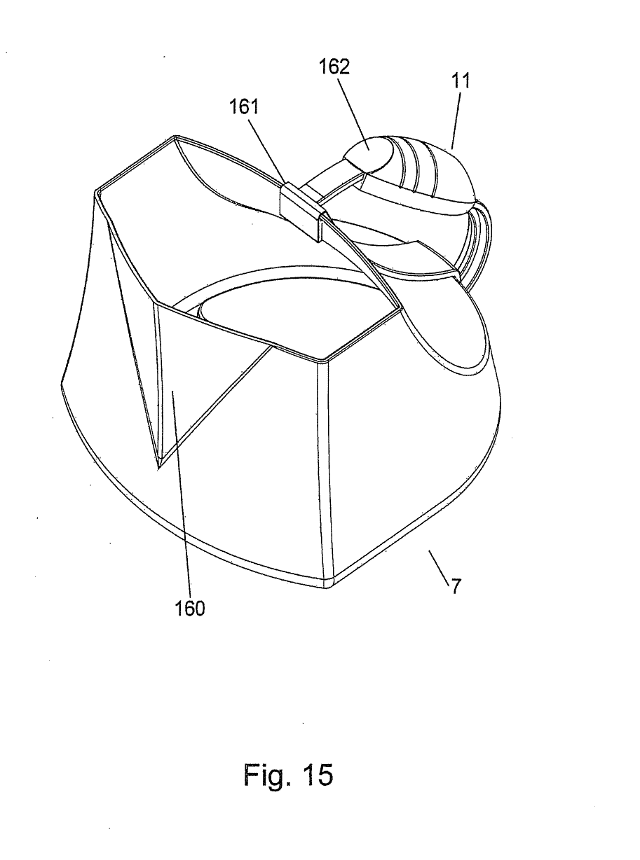

FIG. 15 is a view in perspective of the jar corresponding to this invention; the jar (7) has a big nose (160) that prevents spills at the time of serving the juice; the jar is formed by independent parts joined by adhesive, such as the handle (11), the lid not shown in the figure; the handle lid (162), the handle supporting clip (161), and even the container is an independent piece that has a capacity of 1.3 liters. The jar is adapted to collect juice without allowing spills when it is not filled up.

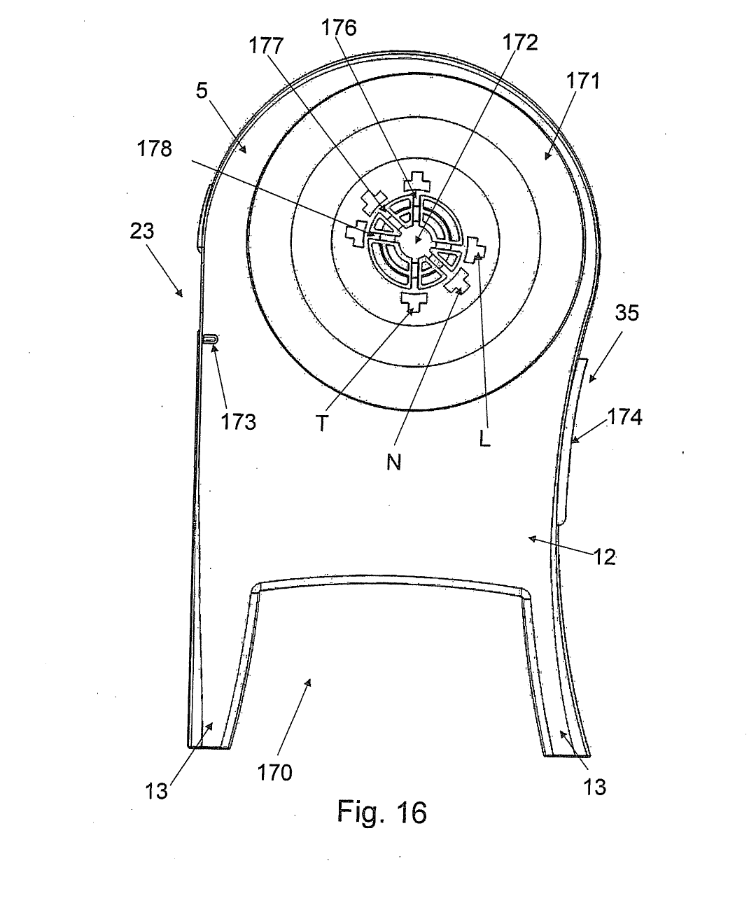

FIG. 16 is a front view of the squeezer front lid (5) corresponding to this invention; the upper round section (171) that lodges the bobbin rotating body in its inside has to be highlighted; at the center of the round section, it has a round hole (172) with notches that extend in radial direction in order to form a diversity of grooves (176, 177 and 178), which are crowned at each one of the ends by the corresponding rabbets (L, N and T) with the aim of lodging each one of the knob positions that, in that way, define the separation among the squeezing surfaces of the bobbin and the volute. The front lid contributes to define the inlet opening (23) that lodges the ramp where the citrus halves are introduced, and in this section, it has the groove (173) that lodges the safety pin to activate the corresponding micro-switch; it also contributes to define the outlet opening (35) and it has the supporting flange (174) for supporting the casing that protects the exit ramp; below the round body, it defines a flat and inclined section (12) that contributes with an edge to form the lower window (170) where the collection jar is introduced; the window is formed by an upper edge that borders on the flat section (12), and two side legs (13) that allow to close the side edges of the intermediate casing.

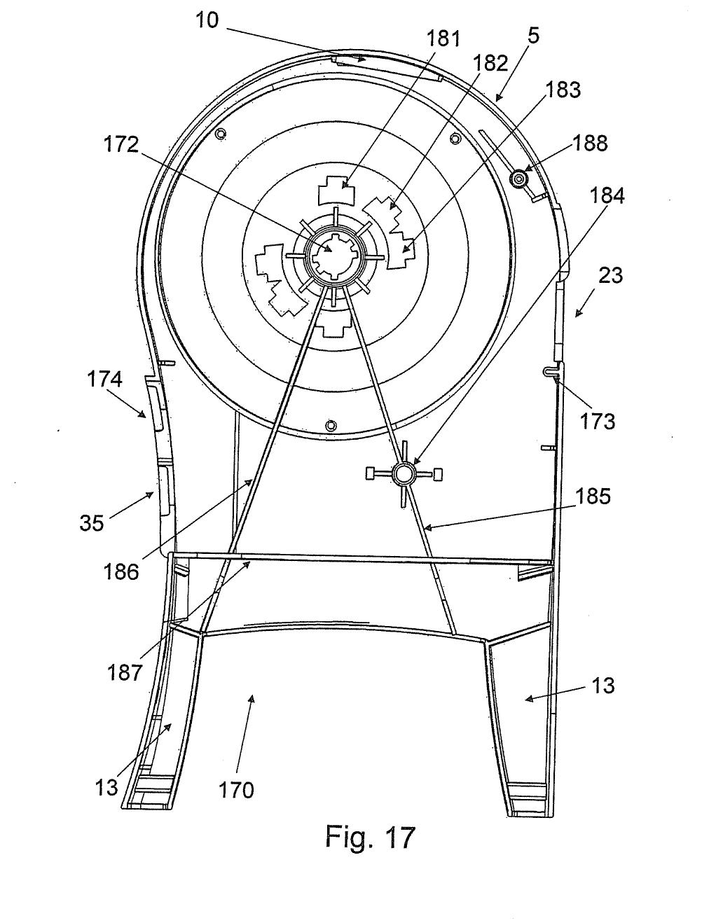

FIG. 17 is a front view of the rear face corresponding to the front lid (5) with the round body in the upper section and whose center has a hole (172) with side notches that are diametrically opposed, and shoulders (181, 182 and 183) that are diametrically opposed to the notches defining the position of the knob to select the opening between the bobbin and the volute surfaces; the closing and safety element (10) is located in the upper end of the front lid, and another safety element, such as a rib and the hole (188) lodging the pin that activates the corresponding micro-switch, is located on one edge; the inner face of the front lid has ribs that increase the body resistance to the stresses produced by the activation of the motor and the squeezing work, elements, such as the rib (186, 185) and the transverse rib (187), the reinforcing cylindrical body (184). The inlet opening (23) has, in its lower proximity, a groove (173) that lodges the safety pin of the access ramp; the outlet opening (35) has, on its edge, the supporting flange (174) that supports the exit ramp casing; the side legs (13) form the framework that defines the opening (170) lodging the collection jar body.

1. A juice squeezer comprising:
an intermediate casing comprising a front face and a rear face, a first and second side surface, a base, and a transverse wall, the transverse wall comprising a lower section, an inclined section, and an upper section, the three sections arranged to define a step;
a squeezing device disposed on the front face, comprising a rotating bobbin-shaped roller (hereinafter, the bobbin) having a concave surface, and a rotating volute-shaped roller (hereinafter, the volute) having a convex surface complementary to the bobbin;
an inlet window and an outlet window disposed on the first and second side surfaces, respectively;
a transmission system disposed on the rear face, the system comprising a motor which is horizontally-positioned at the base, a plurality of safety switches, and a plurality of gears having a stepped ascending cascade configuration, wherein the plurality of gears may rotate the bobbin and volute on the front face of the intermediate casing when the plurality of safety switches allow motion;
an access ramp disposed at the inlet window;
an exit ramp with a protecting outer casing, disposed at the outlet window;
a rear lid comprising reinforcing ribs and posts or level spacers;
a front lid which covers the bobbin and the volute, and which defines a lower window; and
a chute, disposed at the lower window of the front lid.

2. The juice squeezer according to claim 1, wherein the rear lid further comprises:
guides which support shafts and bolts on which are disposed the gears, motor, and a plurality of posts, the plurality of posts defining the separation distance between the rear lid and the intermediate casing;
lower side windows which allow ventilation; and
a three-position switch.

3. The juice squeezer according to claim 1, wherein the base of the intermediate casing comprises two dowels; and
wherein the transverse wall is hermetically sealed such that the passage of juice through or around the transverse wall is prevented.

4. The juice squeezer according to claim 1, wherein the bobbin is coupled to the outer surface of the volute, and
wherein the chute comprises side walls that direct a flow of juice.

5. The juice squeezer according to claim 1, further comprising a container disposed at the chute, the container comprising a cap and handle, the cap comprising a filling hole corresponding to the chute.

6. The juice squeezer according to claim 1, wherein the bobbin and the volute are disposed above the inclined section of the transverse wall, such that the concave and convex surfaces coincide.

7. The juice squeezer according to claim 1, wherein the volute gear and the bobbin gear are disposed within respective perimeter walls and reinforced with transverse ribs.

8. The juice squeezer according to claim 1, wherein the plurality of safety switches comprise safety switches distributed along the edges of the rear face and corresponding to the access ramp, the exit ramp, and the rear lid, respectively.

9. The juice squeezer according to claim 1, wherein the motor is disposed below the inclined section of the transverse wall.

10. The juice squeezer according to claim 1, wherein the plurality of gears comprises a helical gear coupled to the motor, the helical gear comprising a calibrated pressure or clutch system which protects the transmission system against damages in cases of fruit jams.

11. The juice squeezer according to claim 1, wherein the stepped ascending cascade configuration of the plurality of gears incorporates a spindle of the motor; and wherein seats of the plurality of gears are reinforced with ribs.

12. The juice squeezer according to claim 1, wherein the access ramp comprises a plurality of access ramps of different dimensions, wherein any one of the plurality of access ramps may be disposed at the inlet window at a time, and wherein any of the plurality of access ramps may be removed from the inlet window and disposed elsewhere.

13. The juice squeezer according to claim 1, wherein the exit ramp comprises a lid, which prevents access to an interior of the intermediate casing.

14. The juice squeezer according to claim 1, wherein the access ramp comprises a secondary casing with a groove to receive a clip, and a safety bolt disposed in the lid which, when the lid is assembled, activates a safety micro-switch.

15. The juice squeezer according to claim 1, wherein the plurality of safety switches comprise independent safety switches disposed on the rear face and corresponding to the access ramp, the exit ramp, and the rear lid, respectively, and
wherein, when the access ramp, the exit ramp, or the rear lid is not assembled properly, the corresponding safety switch of the independent safety switches deactivates the squeezer.

16. The juice squeezer according to claim 1, wherein the concave surface of the bobbin comprises two metal plates with pin surfaces attached to the bobbin,
wherein the two metal plates have been subjected to an over-molding, and are placed in the mold while plastic is injected so that the plates remain fused with the structural body of the bobbin.

17. The juice squeezer according to claim 1, wherein the volute comprises two parts which are mirrors of each other, which are joined by means of ultrasound.

18. The juice squeezer according to claim 1, wherein the chute concentrates the flow of juice in order to direct it to an opening of a container; and
wherein the chute may slide into and out of position at the lower window of the front lid.

19. The juice squeezer according to claim 1, wherein the front lid comprises:
a rectangular hole to receive a clip that is anchored to the intermediate casing; and
a knob that rotates to adjust the gap between the convex and concave surfaces of the volute and bobbin, respectively.
